(19) United States
(12) Patent Application Publication
(10) Pub. No.: US 2006/0076323 A1
(43) Pub. Date: Apr. 13, 2006

(54) Method and apparatus for laser drilling

(75) Inventors: Kunio Arai, Kanagawa (JP); Kazuhisa Ishii, Kanagawa (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Via Mechanics, Ltd., Kamiimaizumi Ebina-shi (JP)

(21) Appl. No.: 11/243,998

(22) Filed: Oct. 6, 2005

Related U.S. Application Data
(62) Division of application No. 10/854,214, filed on May 27, 2004.

(30) Foreign Application Priority Data
Nov. 26, 2001 (JP) JP 2001-359425

(51) Int. Cl. B23K 26/38

(52) U.S. Cl. 219/121.7; 156/344; 156/584

(57) ABSTRACT

There is provided a laser drilling method that prevents hanging, expansion, or crinkles of copper foil caused when an ultraviolet laser beam that requires no surface roughening is used for a thin double-sided copper-clad film. The drilling method of the copper-clad film comprises the steps of: using an ultraviolet laser as a laser beam; drilling after bonding a resin film to the backside of the film which is the opposite side to the laser-beam-incidence; and delaminating the resin film on the backside after drilling. The resin film bonded to the backside prevents the copper foil from hanging, thus allowing the laser beam to be efficiently applied to the copper foil, and allowing the copper foil to be completely removed by ablation. In the case of a blind hole, the resin film bonded to the backside prevents expansion of the copper foil. Crinkles can be also prevented.

This application is a divisional application of Ser. No. 10/854,214, filed May 27, 2004.

### BACKGROUND OF THE INVENTION

The present invention relates to a method of and an apparatus preferable for drilling an ultrathin flexible printed circuit board by a laser.

### RELATED ART

Currently used as a flexible printed circuit board on which IC chips or the like are mounted is a double-sided copper-clad film having a polyimide film of about 100 μm thick and copper foils of about 18 μm thick bonded to both sides of the polyimide film. The thicknesses thereof are expected to be thinner, and there is a need for using an ultrathin double-sided copper-clad film having a polyimide film of about 25 to 30 μm thick used as an insulting resin film and copper foils of 3 to 5 μm thick bonded to both sides of the polyimide film. There is also a need for microholes having a diameter of 50 μm or less to be drilled in the film.

As a method of drilling a double-sided copper-clad film using a laser beam, a laser drilling method using a carbon dioxide laser has been used as described in JP-A-10-154730 or JP-A-2000-153384. Because of a high reflectance of copper foil used as a conductor layer at wavelengths (9.3 to 10.6 μm) of infrared light emitted from the carbon dioxide laser, a method is often used, such that the laser light irradiates the insulating resin directly through an opening of the foil previously removed by chemical etching or the like. Instead of using a chemical etching process, a method is also used, such that the copper foil is drilled directly by roughening the surface of the copper foil (a roughness of about 2 μm) to increase the absorptance of the surface as described in JP-A-9-107168.

On the other hand, it is known that in order to eliminate such chemical etching or surface roughening of the copper foil, an ultraviolet laser beam (a wavelength of 400 nm or less) to which metals have high absorptance may be applied as described in JP-A-2000-511113.

In view of mass productivity, it is desirable to eliminate chemical etching and to drill the copper foil directly. However, in the case of directly drilling a double-sided copper-clad film having a copper foil of 3 to 5 μm thick by a carbon dioxide laser, the copper foil is too thin to perform surface roughening that requires a roughness of at least 2 μm.

On the other hand, using an ultraviolet laser beam allows the copper foil with less surface roughness to be drilled. However, experiments by the inventors have revealed that when a through hole is drilled as shown in FIG. 4, a double-sided copper-clad film is crinkled and deformed because of a small total thickness of 30 to 40 μm including an insulating resin film and copper foils on both sides. The experiments have also revealed that the uneven intensity distribution of the laser beam impractically causes the remainder of the copper foil to hang 3 just before the hole is completed through the copper foil, though this may also occur in a current 18-μm-thick copper foil regardless of the thickness of copper foil. Here, reference numeral 1 denotes a double-sided copper-clad film consisting of an insulating resin film 12 and copper foils 11 and 13. Reference numeral 5 denotes an incident direction of the ultraviolet laser beam. After the through hole is formed, the effect of suction by a vacuum chuck table generally used is reduced to cause the film to be raised from the table. Further, the laser beam having passed through the double-sided copper-clad film in through hole drilling may damage the work table beneath the film. Further, when a thin double-sided copper-clad film having a total thickness of 30 to 40 μm including a thickness of an insulating resin film is drilled, sucking holes of the vacuum chuck table generally have a diameter of about 3 mm, which may cause bending and displacement from the focusing positions of the laser at the sucking holes.

The experiments have also revealed that when a blind hole (a hole with a bottom) is to be drilled, expansion 4 impractically occurs as shown in FIG. 5. Here, reference numeral 1 denotes a double-sided copper-clad film consisting of an insulating resin film 12 and copper foils 11 and 13. Reference numeral 5 denotes an incident direction of an ultraviolet laser beam. This case may also cause bending and displacement from the focusing positions of the laser at sucking holes.

### SUMMARY OF THE INVENTION

It is an object of the invention to provide a laser drilling method that solves the above described problems of the related art, and prevents hanging or expansion of copper foil and deformation such as crinkles of a film when an ultraviolet laser beam that requires no surface roughening is used for a thin double-sided copper-clad film.

It is another object of the invention to provide a method that causes no bending with respect to a vacuum chuck table, no damage to the table, and no reduction in the effect of vacuum suction.

In order to achieve the above described objects, a laser drilling method of drilling by emitting a laser beam to a copper-clad film whose backside has a copper foil bonded to an insulating resin film may be used, comprising the steps of: using an ultraviolet laser as the laser beam; drilling after bonding a resin film to the backside of the copper-clad film; and delaminating the resin film on the backside after drilling. In through hole drilling, the resin film bonded to the backside prevents the copper foil from hanging, thus allowing the laser beam to be efficiently applied to the copper foil, and allowing the copper foil to be completely removed by ablation (vaporization in atoms or clusters by breaking chemical bonds or melting). Such an advantage is for the remaining layer just before the hole is completed through the copper foil, and is thus not affected by the thickness of the copper foil or the copper foil placed on the laser beam incidence side.

Setting a drilling condition so as to stop drilling at some midpoint of the resin film bonded to the backside prevents damage to the work table, and causes no reduction in the effect of vacuum suction since the hole is not drilled through the resin film.

In the case of a blind hole, the resin film bonded to the backside prevents the expansion of the copper foil.

The resin film bonded to the backside increases the thickness of the work and makes the work solid, thus preventing deformation of the film such as crinkles, and preventing bending with respect to the vacuum chuck table. The thickness of the resin film of 25 μm or more is effective, and the thickness of 50 μm or more is more preferable in practical use.

A polyethylene based film is preferable as the resin film to be bonded to the backside.

As an apparatus for carrying out a method of drilling a copper-clad film comprising the steps of using an ultraviolet laser as a laser beam, drilling after bonding a resin film to a backside of the film which is the opposite side to the laser-beam-incidence, and delaminating the resin film on the backside after drilling, a preferable laser drilling apparatus is comprising supply rollers for the copper-clad film and the resin film, heating rollers for heating and applying pressure to bond the copper-clad film and the resin film together (hereinafter referred to as thermocompression bonding), an ultraviolet laser drilling portion, a delaminating portion for delaminating the copper-clad film and the resin film after laser drilling, and winding rollers for winding the delaminated copper-clad film and the delaminated resin film.

Other objects, features and advantages of the invention will become apparent from the following description of the embodiments of the invention taken in conjunction with the accompanying drawings.

### BRIEF DESCRIPTION OF THE DRAWINGS

FIG. 1 is an illustration of a drilling method according to the invention;

FIG. 2 is a schematic view of an equipment used in the drilling method according to the invention;

FIG. 3 is a schematic view of another equipment used in the drilling method according to the invention;

FIG. 4 is an illustration of forming a through hole by a conventional drilling method; and

FIG. 5 is an illustration of forming a blind hole by a conventional drilling method.

### DETAILED DESCRIPTION OF PREFERRED EMBODIMENTS

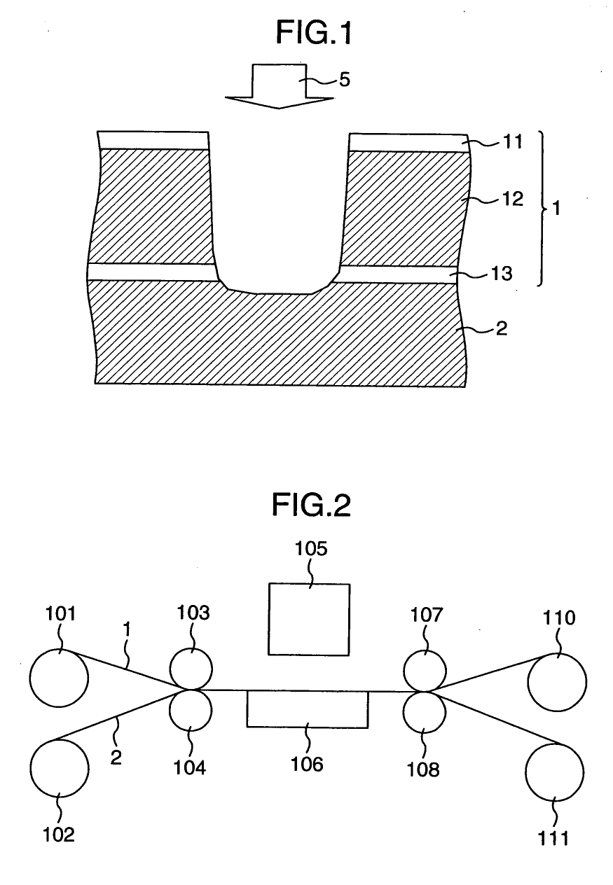

Now, an embodiment of the invention will be described with reference to the drawings. FIG. 1 is an illustration of a drilling method according to the invention. Here, reference numeral 1 denotes a double-sided copper-clad film (a width of 70 to 500 mm) consisting of copper foils 11 and 13 of 3 to 5 μm thick whose surfaces are not roughened, and a polyimide insulating resin film 12 of 25 to 30 μm thick. The copper foil 11 is not always necessary in the laser drilling method according to the invention, and the copper foil 13 having a current thickness of 18 μm or more is similarly processable. Reference numeral 2 denotes a resin film bonded to the backside thereof, and reference numeral 5 denotes an incident direction of an ultraviolet laser beam. A polyethylene based material is preferable as the resin film 2. The thickness of 25 μm or more is effective, and the thickness of 50 μm or more is more preferable in practical use. The example in FIG. 1 shows a through hole formed. The bonded resin film to the backside for drilling by the ultraviolet laser beam prevents the backside copper foil 13 from hanging 3, and by delaminating the resin film 2 thereafter the through hole is obtained with no problem in shape. Thermocompression bonding of the resin film 2 with an appropriate strength reduces the remainder of the resin film 2 in delamination. Drilling is stopped at some midpoint of the resin film 2, thus causing no damage to a vacuum chuck +table 106 and no reduction in the effect of vacuum suction of the table 106, and reinforcement by the resin film 2 can prevent generation of deformation such as bending at sucking holes (having a diameter of 3 mm) of the table 106 and crinkles.

In the case of forming a blind hole, the resin film 2 bonded to the backside prevents the expansion 4 of the copper foil as in FIG. 4.

The resin film 2 does not have to be delaminated immediately after laser drilling, and thus can be used as a protection film for the backside of the double-sided copper-clad film if kept bonded until when delamination is required in a next process and after.

FIG. 2 shows a configuration of a laser drilling apparatus suitable for the drilling method according to the invention. Reference numeral 101 denotes a supply roll for a copper-clad film 1 to be drilled; 102, a supply roll for the resin film 2; 103 and 104, rollers for thermocompression bonding; 105, an ultraviolet laser drilling head; 106, a vacuum chuck table; 107 and 108, delaminating portion guide roller for delaminating the resin film from the copper-clad film; 110, a winding roll for the drilled copper-clad film; and 111, a winding roll for the resin film. The apparatus first widens a gap between the thermocompression rollers 103 and 104 and a gap between the delaminating portion guide rollers 107 and 108, and mounts a roll of the copper-clad film and a roll of the resin film from the supply rolls 101 and 102 via the table 106 to the winding rolls 110 and 111. Then, the thermocompression rollers 103 and 104 are pressed against each other, and when a thermocompression bonded portion of the copper-clad film 1 and the resin film 2 reaches the work table 106, the ultraviolet laser drilling head 105 starts drilling. The delaminating portion guide rollers 107 and 108 are lightly pressed against each other to the extent that the height of the film on the work table does not change. After passing through the guide rollers, the resin film and the copper film are pulled by the winding rollers 110 and 111 upward and downward, respectively, and then the resin film is delaminated from the copper film. Thus, this apparatus allows automatic operations of bonding the resin film to the backside and delaminating after drilling.

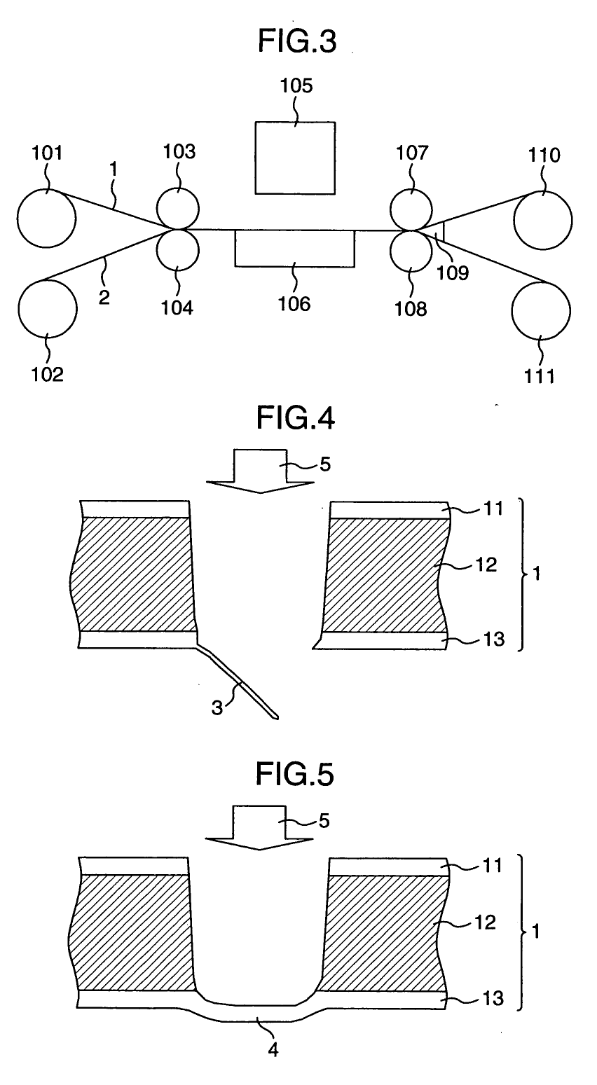

FIG. 3 shows a configuration of a laser drilling device having a wedge-like delamination member 109 added to the delaminating portion of the apparatus in FIG. 2. Adding the wedge-like delamination member 109 stabilizes delamination of the copper-clad film and the resin film.

Bonding the resin film to the backside for drilling by the ultraviolet laser beam eliminates the need for surface roughening to allow drilling of the thin copper foil, and prevent hanging or expansion of the copper foil.

Increasing the thickness by the resin film reduces deformation such as bending and crinkles with respect to the vacuum chuck table, and thus prevents damage to the work table and reduction in the effect of the vacuum suction.

It should be further understood by those skilled in the art that although the foregoing description has been made on embodiments of the invention, the invention is not limited thereto and various changes and modifications may be made without departing from the sprit of the invention and the scope of the appended claims.

What is claimed is:

1. A laser drilling device comprising:
supply rollers for a copper-clad film whose backside has a copper foil bonded to an insulating resin film and a resin film;
heating rollers for heating and applying pressure to bond the copper-clad film and the resin film together;
an ultraviolet laser drilling portion;
a delaminating portion for delaminating the copper-clad film and the resin film after laser drilling; and
winding rollers for winding the delaminated copper-clad film and the delaminated resin film.
